(19) United States
(12) Patent Application Publication
(10) Pub. No.: US 2011/0045772 A1
(43) Pub. Date: Feb. 24, 2011

(54) TRIGGERING CONTROL DEVICE AND METHOD THEREOF

(75) Inventors: Ting-Lin Chang, Taoyuan County (TW); Ching-Feng Hsieh, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: Askey Computer Corp., Taipei (TW)

(21) Appl. No.: 12/560,986

(22) Filed: Sep. 16, 2009

(30) Foreign Application Priority Data
Aug. 18, 2009 (TW) 098127745

(51) Int. Cl. H04B 7/00

(52) U.S. Cl. 455/41.2

(57) ABSTRACT

A triggering control device for enabling a data collection host assembled on it to execute a corresponding function action comprises a Bluetooth communication module, a control module, a power supply module and a housing containing the foregoing components. The Bluetooth communication module for communicating the triggering control device is controlled by the control module to drive the Bluetooth communication module to output a triggering signal, and the data collection host is enabled while receiving the triggering signal. Thereby, the triggering control device enables the data collection host to proceed a functional action by the Bluetooth communication module, so as to solve the contact fault or interference problem of the prior art.

### CROSS-REFERENCE TO RELATED APPLICATIONS

This non-provisional application claims priority under 35 U.S.C. §119(a) on Patent Application No(s). 098127745 filed in Taiwan, R.O.C. on 18 Aug. 2009, the entire contents of which are hereby incorporated by reference.

### FIELD OF THE INVENTION

The present invention relates to a triggering control technology, and more particularly to a device and a method of performing a triggering control to a data collection host by a Bluetooth communication method.

### BACKGROUND OF THE INVENTION

Data collection host is a device for retrieving various different data and generally installed with a triggering controller, and a common data collection host includes a barcode reader and a barcode scanner, and the triggering controller is mainly provided for facilitating a user to operating various different functions of the data collection host. The barcode reader is a tool for reading a barcode, such as a barcode number 1234, and the barcode reader will receive a digital data representing 1234. In addition, the functions of the barcode scanner and the barcode reader are very similar, and an operating system and a storage medium are usually built in the barcode scanner and reader, such that when data are collected, the data are stored in the storage medium for further calculation and management, and then the data are inputted into a computer for comparison, or transferred from the data collection host to other devices, and thus such data collection host is very suitable for inventory count, asset count or shipping procedure.

A handheld triggering controller of the conventional data collection host is connected directly to a machine interface for triggering the data collection host to execute a data collection. In general, an opening is designed on the triggering controller and a main body of the data collection host for installing a link mechanism (such as a communication line), such that the triggering controller can enable the data collection host through the link mechanism to execute different data collection functions during an operation.

After a long time of use adopting the aforementioned operating method, the link mechanism may be damaged easily, and a fault trigger may occur. Furthermore, both triggering controller and host have an opening, and thus it is more likely for water or dust to enter into the triggering controller and the host.

To overcome the foregoing shortcomings, a conventional infrared communication method is used for triggering the data collection host directly, or a conventional magnetic sensing method is used for triggering the data collection host to enable a function.

Since the data collection host of the triggering controller is plugged, unplugged or replaced frequently due to different occasions or different functional requirements, a transparent window used in the infrared communication for receiving infrared rays will be worn out or damaged easily when the triggering controller is plugged and unplugged with the data collection host frequently, and thus a low penetration rate is resulted to cause a fault trigger or a poor triggering effect.

Another conventional magnetic sensing method is used for the triggering function. Although such method can avoid the issues created by the infrared communication method and the poor contact of the communication line, yet the magnetic sensing method is affected by the using environment easily to cause a sensing failure of the data collection host or a wrong execution by the data collection host.

Therefore, it is a subject of the present invention to disclose a way of overcoming the aforementioned shortcomings of the conventional voice triggering control device and data collection host.

### SUMMARY OF THE INVENTION

Therefore, it is a primary objective of the present invention to provide a triggering control device and a method of the present invention to prevent a triggering fault due to a poor contact or an environmental influence.

Another objective of the present invention is to provide a triggering control device that provides a better waterproof and dustproof effect.

To achieve the foregoing objectives, the present invention provides a triggering control device for enabling a data collection host connected to the triggering control device to execute a corresponding functional action, and the triggering control device comprises: a Bluetooth communication module, for transmitting a triggering signal to enable the data collection host to execute a corresponding functional action; a control module, electrically coupled to the Bluetooth communication module, for controlling a transmission of the triggering signal; a power supply module, electrically coupled to the Bluetooth communication module, for supplying a required electric power; and a housing, for containing the Bluetooth communication module, the control module and the power supply module, and connecting a connection portion to the data collection host.

In a preferred embodiment of the invention, the housing includes a holding structure for facilitating users to grip the housing. The control module includes a press-button switch provided for outputting a start signal to control a transmission of the triggering signal.

To achieve the foregoing objective, the present invention also provides a triggering control method, comprising the steps of: using a Bluetooth communication module built in the triggering control device to establish a connection between the triggering control device and the data collection host; controlling the Bluetooth communication module by a control module installed on the triggering control device to drive the Bluetooth communication module to transmit a triggering signal; and enabling the data collection host upon receipt of the triggering signal.

Unlike the prior art, bodies of the triggering control device and the data collection host in accordance with the present invention do not require any additional opening for installing the communication line to provide better waterproof and dustproof effect. In addition, the wireless triggering method adopting the Bluetooth communication can provide a stable operation for the data collection host without the poor contact issue, and signals of the Bluetooth communication will not be interfered by the using environment easily, and thus the present invention can reduce the possibility of a wrong triggering.

### BRIEF DESCRIPTION OF THE DRAWINGS

FIG. 1 is a functional block diagram of controlling a data collection host in accordance with a preferred embodiment of the present invention;

FIG. 2 is a schematic view of controlling a data collection host in accordance with another preferred embodiment of the present invention; and

FIG. 3 is a flow chart of controlling a data collection host in accordance with a preferred embodiment of the present invention.

### DESCRIPTION OF THE PREFERRED EMBODIMENT

Other features and advantages of the present invention will become apparent in the following detailed description of the preferred embodiments with reference to the accompanying drawings.

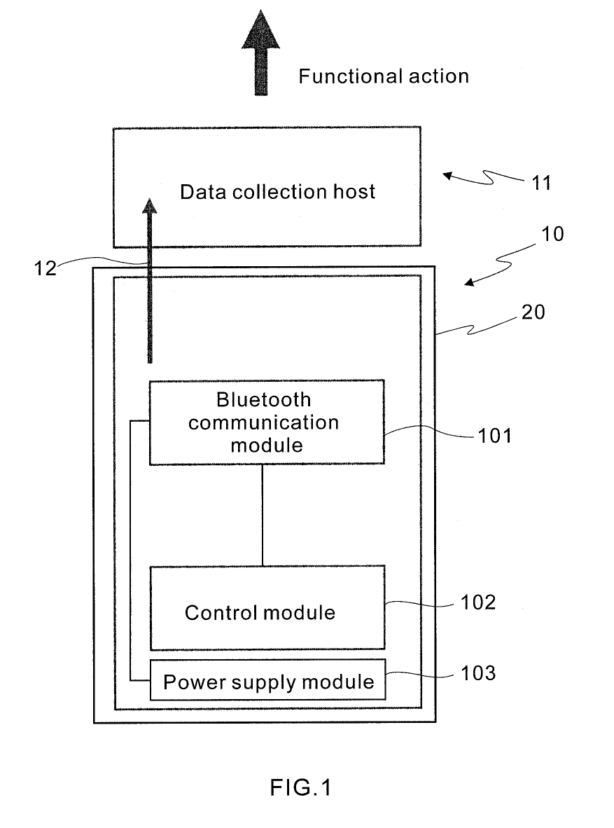

With reference to FIG. 1 for a functional block diagram of controlling a data collection host in accordance with a preferred embodiment of the present invention, the triggering control device is used for enabling a data collection host connected to the triggering control device to drive the data collection host to execute a corresponding functional action. In FIG. 1, a triggering control device 10 is provided for triggering a data collection host 11 to drive the data collection host 11 to execute a corresponding functional action. The triggering control device 10 comprises: a Bluetooth communication module 101, a control module 102, a power supply module 103 and a housing 20 for containing the foregoing components. The control module 102 is electrically coupled to Bluetooth communication module 101, and the power supply module 103 is electrically coupled to the Bluetooth communication module 101, for supplying an electric power required by the triggering control device 10. The housing 20 contains the Bluetooth communication module 101, control module 102 and the power supply module 103.

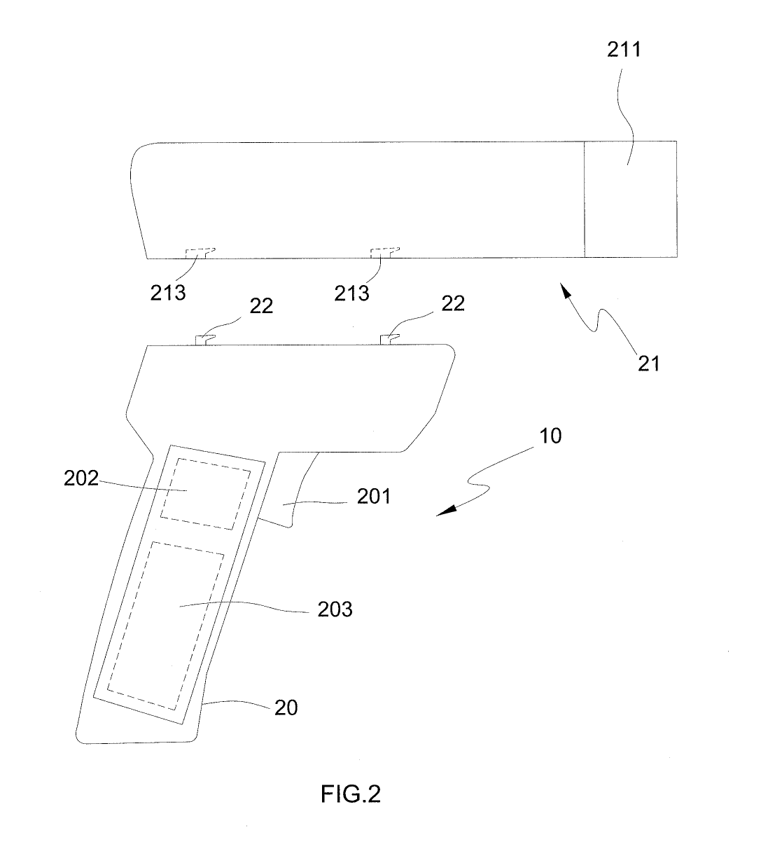

In a preferred embodiment, a user controls the Bluetooth communication module 101 by the control module 102, such that the Bluetooth communication module 101 transmits a triggering signal 12 for enabling the data collection host 11, and then the data collection host 11 receives the triggering signal 12 and is enabled to execute a corresponding functional action. With reference to FIG. 2 for a schematic view of installing a triggering control device onto a data collection host in accordance with another preferred embodiment of the present invention, the triggering control device 10 comprises a Bluetooth communication module 202, a control module 201, a power supply module 203 and a housing 20. The housing 20 includes a holding structure, for facilitating a user to grip the housing 20. The invention is not limited to such arrangement only, but any structure facilitating a user's grip can be used in the present invention. The housing 20 of the triggering control device 10 can be coupled to a connection portion 213 corresponding to the data collection host 21 through a connection portion 22 or any other connection methods, wherein the connection portion 22 is a tenon. The housing 20 contains the control module 201, the Bluetooth communication module 202 and the power supply module 203. In this preferred embodiment, the control module 201 comprises a press-button switch, and the power supply module 203 is a rechargeable battery module, and the data collection host 21 includes a scanning module 211 with a function of executing a scanning function. The triggering control device 10 is supplied with electric power by a rechargeable battery module, or supplied with utility power through an adapter in another preferred embodiment, or the utility power is used for charging the rechargeable battery module.

In a preferred embodiment, a user can press the press-button switch to control the Bluetooth communication module 202, such as pressing the switch to transmit a triggering signal, or not transmitting the triggering signal if the switch is not pressed. The data collection host 21 is enabled after it has received the triggering signal, such that the data collection host 21 is selectively enabled to execute a corresponding functional action. For example, if a user presses a press-button switch marked with “SCAN”, then the Bluetooth communication module 202 will transmits a triggering signal of a Bluetooth communication protocol. The data collection host 21 receiving the triggering signal is enabled to drive the scanning module 211 to execute a data scanning action.

In another preferred embodiment, the scanning module is replaced by an image capturing module installed in the data collection host 21 for executing an image capturing action. However, it is noteworthy to point out that persons ordinarily skilled in the art can use any other data collection related module and functional actions for the present invention. The invention is not limited to the data scanning action or the image capturing action only. The data collection host 21 enabled for executing a corresponding functional action can be set by a user. In other words, the enabling method of the present invention is mainly to enable the data collection host 21, and any predetermined functional action can be executed.

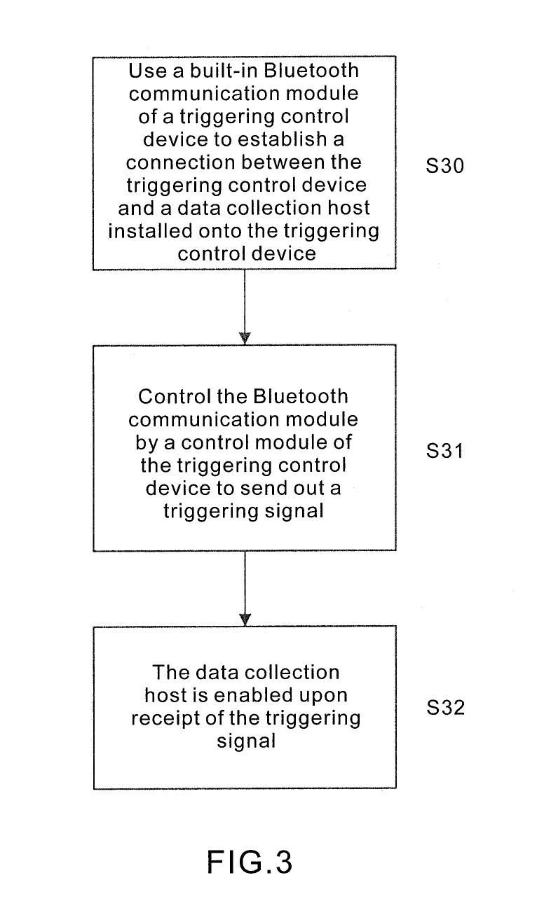

With reference to FIG. 3 for a flow chart of controlling a data collection host in accordance with a preferred embodiment of the present invention, this preferred embodiment provides a triggering control method for enabling a data collection host coupled to a triggering control device. In Step (S30), a Bluetooth communication module built in a triggering control device is used for creating a connection between the triggering control device and the data collection host installed onto the triggering control device. In Step (S31), a control module of the triggering control device is used for controlling the Bluetooth communication module for transmitting a triggering signal. In Step (S32), the data collection host is enabled upon the receipt of the triggering signal.

The present invention uses the aforementioned triggering control device and method to transmit a triggering signal from the triggering control device by a Bluetooth communication method to the data collection host installed onto the triggering control device, such that the data collection host executes a corresponding functional action. Since there is no opening or link mechanism between the triggering control device and the data collection host, therefore the problem of the triggering fault caused by the environmental influence in the prior art can be overcome, and the triggering control device can achieve the waterproof and dustproof effect.

While the invention has been described by means of specific embodiments, numerous modifications and variations could be made thereto by those skilled in the art without departing from the scope and spirit of the invention set forth in the claims.

What is claimed is:

1. A triggering control device, for enabling a data collection host connected to the triggering control device to execute a corresponding functional action, and the triggering control device comprising:
a Bluetooth communication module, for transmitting a triggering signal to enable the data collection host to execute the corresponding functional action;
a control module, electrically coupled to the Bluetooth communication module, for controlling a transmission of the triggering signal;
a power supply module, electrically coupled to the Bluetooth communication module, for supplying a required electric power; and
a housing, for containing the Bluetooth communication module, the control module and the power supply module, and having a connection portion provided for connecting the data collection host.

2. The triggering control device of claim 1, wherein the housing includes a holding structure.

3. The triggering control device of claim 1, wherein the control module a press-button switch for outputting a start signal to control an output of the high-frequency audio signal.

4. The triggering control device of claim 1, wherein the connection portion is a connecting tenon.

5. The triggering control device of claim 1, wherein the power supply module is a rechargeable battery module.

6. A triggering control method, used for enabling a data collection host connected to the triggering control device to execute a corresponding functional action, and the triggering control method comprising the steps of:
using a Bluetooth communication module built in the triggering control device to establish a connection between the triggering control device and the data collection host;
controlling the Bluetooth communication module by a control module installed on the triggering control device to drive the Bluetooth communication module to transmit a triggering signal; and
enabling the data collection host upon receipt of the triggering signal.
